(19) United States
(12) Patent Application Publication
(10) Pub. No.: US 2026/0218332 A1
(43) Pub. Date: Jul. 30, 2026

(54) METHOD OF PREPARING ZINC-CONTAINING MATERIAL, METHOD OF PREPARING ELECTROGALVANIZING BATH, AND METHOD OF PRODUCING ELECTROGALVANIZED STEEL SHEET

(71) Applicant: JFE STEEL CORPORATION, Chiyoda-ku, Tokyo (JP)

(72) Inventors: Yukichika HASHIZUME, Chiyoda-ku, Tokyo (JP); Mariko SHINODA, Chiyoda-ku, Tokyo (JP); Kazuaki TSUCHIMOTO, Chiyoda-ku, Tokyo (JP); Takeshi MATSUDA, Chiyoda-ku, Tokyo (JP); Daisuke MIZUNO, Chiyoda-ku, Tokyo (JP)

(73) Assignee: JFE STEEL CORPORATION, Chiyoda-ku, Tokyo (JP)

(21) Appl. No.: 19/151,998

(22) PCT Filed: Mar. 11, 2024
(86) PCT No.: PCT/JP2024/009433

§ 371 Date: Jul. 30, 2025

(30) Foreign Application Priority Data
Mar. 13, 2023 (JP) 2023-039112

(51) Int. Cl. C22B 3/00; C22B 3/08; C22B 3/20; C22B 3/22; C22B 3/44; C25D 3/22

(52) U.S. Cl. CPC C22B 19/22; C22B 3/08; C22B 3/205; C22B 3/22; C22B 3/44; C22B 19/26; C25D 3/22

(57) ABSTRACT

A zinc-containing material that can be used to produce electrogalvanized steel sheets with a beautiful, bright appearance is provided. Included are a zinc leaching step of bringing steelmaking dust into contact with an acidic aqueous solution to leach zinc into the solution, a first impurity precipitation step of precipitating impurities in a first treatment solution obtained in the zinc leaching step, a second impurity precipitation step of adding a chelating agent to a second treatment solution, obtained in the first impurity precipitation step to precipitate impurities, a first solid-liquid separation step of subjecting a third treatment solution, obtained in the second impurity precipitation step, to solid-liquid separation, a zinc precipitation step of precipitating a zinc-containing material in a fourth treatment solution obtained in the first solid-liquid separation step, and a second solid-liquid separation step of subjecting a fifth treatment solution obtained in the zinc precipitation step to solid-liquid separation.

### TECHNICAL FIELD

The present disclosure relates to a method of preparing a zinc-containing material, a method of preparing an electrogalvanizing bath, and a method of producing an electrogalvanized steel sheet.

### BACKGROUND

Zinc, a typical base metal, is used in diverse industrial fields. In particular in the steel industry, zinc provides excellent corrosion resistance by virtue of having a low electrical potential relative to iron and a sacrificial protection effect. Therefore, zinc is used as a plating material for the surface of steel sheets and is widely used in automobiles, home appliances, building materials, and the like.

Commonly used methods of producing galvanized steel sheets include a hot-dip galvanizing method in which a galvanized layer is formed on the surface of a steel sheet by immersing the steel sheet in a hot-dip galvanizing bath, and an electrogalvanizing method in which a steel sheet is immersed in an acidic solution containing zinc ions to deposit a galvanized layer on the surface of the steel sheet by an electrochemical reaction. In both methods, metallic zinc is often used as a zinc raw material, but the price of metallic zinc has been rising in recent years as the supply and demand balance has changed with the rise of emerging economies.

In response to this situation, attempts have been made to separate and recover industrial waste and steelworks byproducts composed of zinc and other metals as an alternative zinc source instead of metallic zinc. For example, since steelmaking dusts such as blast furnace dust, converter dust, and electric furnace dust contain zinc derived from galvanized steel sheet scrap and iron ore, technologies for separating and recovering zinc from steelmaking dust as a zinc source have been reported. For example, Patent Literature (PTL) 1 describes a method in which steelmaking dust is separated into coarse dust and fine dust, the fine dust is brought into contact with acid to leach zinc into the acid, and alkali addition and solid-liquid separation are then repeated to separate and recover the zinc.

### CITATION LIST

### Patent Literature

PTL 1: JP 2022-105980 A

### SUMMARY

### Technical Problem

Among galvanized steel sheets, electrogalvanized steel sheets are often used without coating after chemical conversion treatment and are therefore required to have excellent surface appearance. Whiteness is one of the most important items, and the brightness (L value) is usually used as an index of whiteness. After examination, we discovered that when the zinc separated and recovered by the method described in PTL 1 was used as the zinc raw material for an electrogalvanizing bath, the L value of the plated surface decreased due to impurity metals (for example, Pb and Cd) that were thought to originate from steelmaking dust, and the plated appearance became darker than that of conventional electrogalvanized steel sheets. Therefore, producing an electrogalvanized steel sheet using a zinc-containing material made from zinc separated and recovered from steelmaking dust by the method described in PTL 1 is problematic in that the required appearance cannot be obtained.

It is therefore an aim of the present disclosure to provide a zinc-containing material that is made from steelmaking dust and that can be used to produce electrogalvanized steel sheets with a beautiful, bright appearance.

### Solution to Problem

As a result of keen examination of methods of solving the aforementioned problem, we discovered that, by bringing steelmaking dust into contact with an acidic aqueous solution, leaching the zinc contained in the steelmaking dust into the acidic aqueous solution, setting the pH of the resulting treatment solution (first treatment solution) to 4.0 or more and 6.0 or less, then adding a predetermined amount of chelating agent to the resulting treatment solution (second treatment solution) to precipitate the impurity metals as hydroxides and chelate compounds while maintaining the zinc concentration in the treatment solution, subjecting the resulting treatment solution (third treatment solution) to solid-liquid separation, then setting the pH of the resulting treatment solution (fourth treatment solution) to 8.0 or more and 12.0 or less, and then subjecting the resulting treatment solution (fifth treatment solution) to solid-liquid separation, a zinc-containing material that is free of impurity metals can be obtained. We then discovered that the resulting zinc-containing material can be used as a zinc source in an electrogalvanizing method to produce electrogalvanized steel sheets with a beautiful, bright appearance, thereby completing the present disclosure.

The primary features of the present disclosure are as follows.
[1] A method of preparing a zinc-containing material, the method comprising:
   a zinc leaching step of bringing steelmaking dust into contact with an acidic aqueous solution to leach zinc contained in the steelmaking dust into the acidic aqueous solution;
   a first impurity precipitation step of precipitating impurities while a pH of a first treatment solution obtained in the zinc leaching step is 4.0 or more and 6.0 or less;
   a second impurity precipitation step of adding 0.10 g/L or more of a chelating agent to a second treatment solution, obtained in the first impurity precipitation step, while a pH of the second treatment solution is 4.0 or more and 6.0 or less to precipitate impurities;
   a first solid-liquid separation step of subjecting a third treatment solution, obtained in the second impurity precipitation step, to solid-liquid separation;
   a zinc precipitation step of precipitating a zinc-containing material while a pH of a fourth treatment solution obtained in the first solid-liquid separation step is 8.0 or more and 12.0 or less; and
   a second solid-liquid separation step of separating a fifth treatment solution obtained in the zinc precipitation step into a zinc-containing material and residual liquid.
[2] The method of preparing a zinc-containing material according to [1], further comprising a classifying step of separating steelmaking dust into coarse dust and fine dust in a stage preceding the zinc leaching step, wherein the steelmaking dust used in the zinc leaching step is the fine dust obtained in the classifying step.
[3] The method of preparing a zinc-containing material according to [1] or [2], wherein at least one type of the chelating agent added to the second treatment solution in the second impurity precipitation step is a chelating agent that forms a chelate compound with at least one of Cd and Pb.
[4] The method of preparing a zinc-containing material according to any one of [1] to [3], wherein at least one type of the chelating agent added to the second treatment solution in the second impurity precipitation step is a compound having a structure illustrated in general formula (I) in a portion thereof,

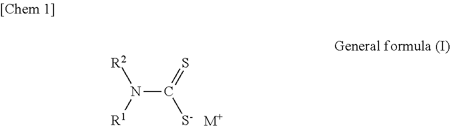

where R¹ and R² represent an optionally substituted alkyl group, and M⁺ represents a monovalent cation.
[5] A method of preparing an electrogalvanizing bath, the method comprising adding a zinc-containing material prepared by the method of preparing a zinc-containing material according to any one of [1] to [4] to an electrogalvanizing bath, wherein a pH of the electrogalvanizing bath is 0.5 or more and 3.5 or less.
[6] A method of producing an electrogalvanized steel sheet, the method comprising electrogalvanizing a surface of a steel sheet using an electrogalvanizing bath prepared by the method of preparing an electrogalvanizing bath according to [5] to produce an electrogalvanized steel sheet.

### Advantageous Effect

According to the present disclosure, a zinc-containing material that is made from steelmaking dust and that can be used to produce electrogalvanized steel sheets with a beautiful, bright appearance can be provided.

### BRIEF DESCRIPTION OF THE DRAWINGS

In the accompanying drawings:

FIG. 1 is a flowchart of an example method of preparing a zinc-containing material according to the present disclosure; and

FIG. 2 is a flowchart of a preferred example method of preparing a zinc-containing material according to the present disclosure.

### DETAILED DESCRIPTION

### (Method of Preparing a Zinc-Containing Material)

Embodiments of the present disclosure are described below. However, the present disclosure is not limited to the following embodiments. In the present specification, a numerical range expressed by using “to” means a range including numerical values described before and after “to” as the lower limit value and the upper limit value.

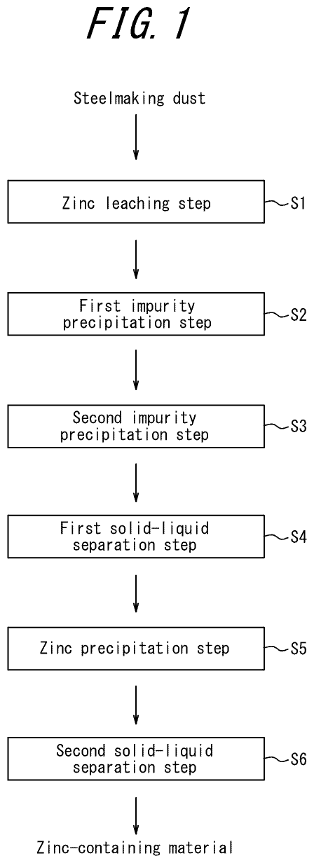

FIG. 1 is a flowchart of an example method of preparing a zinc-containing material according to the present disclosure. A method of preparing a zinc-containing material according to the present disclosure includes a zinc leaching step (step S1) of bringing steelmaking dust into contact with an acidic aqueous solution to leach zinc contained in the steelmaking dust into the acidic aqueous solution, a first impurity precipitation step (step S2) of precipitating impurities while a pH of a first treatment solution obtained in the zinc leaching step is 4.0 or more and 6.0 or less, a second impurity precipitation step (step S3) of adding 0.10 g/L or more of a chelating agent to a second treatment solution, obtained in the first impurity precipitation step, while a pH of the second treatment solution is 4.0 or more and 6.0 or less to precipitate impurities, a first solid-liquid separation step (step S4) of subjecting a third treatment solution, obtained in the second impurity precipitation step, to solid-liquid separation, a zinc precipitation step (step S5) of precipitating a zinc-containing material while a pH of a fourth treatment solution obtained in the first solid-liquid separation step is 8.0 or more and 12.0 or less, and a second solid-liquid separation step (step S6) of separating a fifth treatment solution obtained in the zinc precipitation step into a zinc-containing material and residue.

### <Zinc Leaching Step>

First, in step S1, steelmaking dust is brought into contact with an acidic aqueous solution to leach zinc contained in the steelmaking dust into the acidic aqueous solution (zinc leaching step).

Blast furnace dust, converter dust, electric furnace dust, and the like can be used as the steelmaking dust serving as the raw material.

Common acidic aqueous solutions such as sulfuric acid and hydrochloric acid can be used as the acidic aqueous solution used in the present zinc leaching step. From the perspective of using the finally recovered zinc-containing material for the electrogalvanizing bath, it is desirable to use an acid that contains the same type of anion as the electrogalvanizing bath to be used. When a sulfuric acid bath is used as the electrogalvanizing bath, sulfuric acid is preferably used as the acidic aqueous solution, and when a chloride bath is used as the electrogalvanizing bath, hydrochloric acid is preferably used as the acidic aqueous solution.

No lower limit is placed on the pH of the acidic solution during zinc leaching, but a pH below 1.0 increases the consumption of chemicals, thereby increasing treatment costs. Therefore, the pH of the acidic solution during zinc leaching is preferably 1.0 or more, more preferably 2.0 or more. On the other hand, if the pH of the acidic solution during zinc leaching exceeds 5.0, zinc becomes difficult to leach and cannot be recovered efficiently. Therefore, the pH of the acidic solution during zinc leaching is preferably 5.0 or less, more preferably 4.0 or less, and even more preferably 3.5 or less.

The zinc leaching time is preferably 10 minutes or more. A zinc leaching time of 10 minutes or more allows the zinc to leach sufficiently into the acidic solution, so that zinc can be recovered efficiently. While no upper limit is placed on the zinc leaching time, the zinc leaching time is preferably 120 minutes or less to avoid prolonging the treatment time.

The reaction temperature during zinc leaching can be set freely within a temperature range such that the acidic solution does not coagulate or evaporate. The reaction temperature during zinc leaching is preferably 30° C. or more in consideration of maintaining a constant temperature. The reaction temperature is also preferably 90° C. or less, because an excessively high temperature increases evaporation of the acidic aqueous solution. The acidic solution is preferably stirred during the leaching process. The method of stirring the acidic aqueous solution is not particularly limited, but examples include methods using a stirrer mixer, a propeller mixer, a pump, or the like.

### <First Impurity Precipitation Step>

Next, in step S2, impurities are precipitated while the pH of a first treatment solution obtained in the zinc leaching step is 4.0 or more and 6.0 or less (first impurity precipitation step).

It is thought that the first treatment solution obtained in the zinc leaching step contains impurities, which inevitably leached into the acidic aqueous solution together with zinc from steelmaking dust, in the form of metal ions. These impurities are thought to precipitate together with zinc on the steel sheet during electroplating, thereby reducing the L value of the galvanized steel sheet. Therefore, it is essential to reduce the amount of these impurities in order to obtain an electrogalvanized steel sheet with a beautiful, bright appearance. On the other hand, if zinc is also precipitated when impurities are precipitated, the recycling rate as a raw material for galvanization will also decrease. Therefore, it is necessary to precipitate impurities while maintaining the zinc concentration in the aforementioned first treatment solution.

We diligently studied the conditions under which only impurities are precipitated and separated while maintaining the zinc concentration in the aforementioned first treatment solution. As a result, we discovered that by setting the pH of the aforementioned first treatment solution to 4.0 or more and 6.0 or less (first impurity precipitation step), adding a predetermined amount of a chelating agent to the resulting treatment solution (second treatment solution) to precipitate impurities (second impurity precipitation step), thereby precipitating impurity elements other than zinc as hydroxides and chelate compounds, subjecting the resulting treatment solution (third treatment solution) to solid-liquid separation, then setting the pH of the resulting treatment solution (fourth treatment solution) to 8.0 or more and 12.0 or less, and then subjecting the resulting treatment solution (fifth treatment solution) to solid-liquid separation (second solid-liquid separation step), a zinc-containing material that is free of impurity metals can be obtained. This yields a zinc-containing material suitable for the production of electrogalvanized steel sheets with a beautiful, bright appearance.

Therefore, in the first impurity precipitation step, impurities (mainly Fe) are precipitated as hydroxides while maintaining the zinc concentration in the first treatment solution obtained in the zinc leaching step by setting the pH of the first treatment solution to 4.0 or more and 6.0 or less. By setting the pH of the first treatment solution to 4.0 or more, Fe can be precipitated efficiently. The pH of the first treatment solution is therefore set to 4.0 or more. The lower limit of the pH of the first treatment solution is preferably 4.3, more preferably 4.5. Setting the pH of the first treatment solution to 6.0 or less suppresses precipitation of zinc, maintains the zinc concentration in the solution, and enables efficient recovery of zinc. The pH of the first treatment solution is therefore 6.0 or less. The upper limit of the pH of the first treatment solution is preferably 5.8, more preferably 5.5.

If the pH of the first treatment solution obtained in the zinc leaching step is less than 4.0, the pH of the first treatment solution needs to be adjusted to 4.0 or more and 6.0 or less. Examples of methods of adjusting the pH include adding a common alkaline solution such as sodium hydroxide or calcium hydroxide. On the other hand, if the pH of the first treatment solution obtained in the zinc leaching step is within the range of 4.0 or more and 6.0 or less, the pH does not need to be adjusted.

The temperature of the first treatment solution in the first impurity precipitation step can be set freely within a temperature range such that the first treatment solution does not coagulate or evaporate. The temperature of the first treatment solution is preferably 30° C. or more in consideration of maintaining a constant temperature. The temperature of the first treatment solution is also preferably 90° C. or less, because an excessively high temperature increases evaporation of the first treatment solution. In consideration of the time it takes for impurities to precipitate and of treatment efficiency, the reaction time of the first impurity precipitation step is preferably 10 minutes or more. The reaction time of the first impurity precipitation step is preferably 120 minutes or less.

### <Second Impurity Precipitation Step>

Next, in step S3, 0.10 g/L or more of a chelating agent is added to a second treatment solution, obtained in the first impurity precipitation step, while a pH of the second treatment solution is 4.0 or more and 6.0 or less to precipitate impurities (second impurity precipitation step).

Although some of the impurities (mainly Fe) can be precipitated as hydroxides by the first impurity precipitation step in the preceding stage, heavy metal elements such as Cd and Pb remain in the solution without being precipitated. Therefore, in the second impurity precipitation step, heavy metal elements such as Cd and Pb are precipitated as chelate compounds by the addition of a chelating agent to the second treatment solution obtained in the first impurity precipitation step.

In view of the above-described aim, at least one type of the chelating agent added to the second treatment solution in the second impurity precipitation step is preferably a chelating agent that forms a chelate compound with at least one of Cd and Pb. By use of such a chelating agent, heavy metal elements such as Cd and Pb can be efficiently precipitated as chelate compounds.

In the present disclosure, at least one type of the chelating agent added to the second treatment solution in the second impurity precipitation step is preferably a compound having a structure illustrated in general formula (I) below in a portion thereof. Here, R¹ and R² represent an optionally substituted alkyl group. M⁺ represents a monovalent cation, such as a proton, alkali metal ion, or ammonium ion. Two or more of the structure illustrated in general formula (I) may be included in the compound.

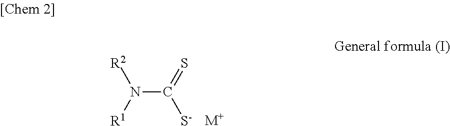

The structure indicated in the above general formula (I) is thought to facilitate the formation of stable complexes with heavy metal elements such as Cd and Pb, since a total of three nitrogen atoms and sulfur atoms with a lone pair of electrons, which are necessary for coordination bonding with metals, are present in the compound.

Examples of compounds having such a structure include dimethyldithiocarbamates, diethyldithiocarbamates, dipotassium piperazine-1,4-dicarbodithioate, potassium diethylamine-N-carbodithioate, and ammonium 1-pyrrolidinedithiocarbamate.

The amount of chelating agent added to the second treatment solution is preferably 0.10 g/L or more to sufficiently reduce the amount of impurity elements. The amount of chelating agent added is more preferably 0.20 g/L or more, and even more preferably 0.50 g/L or more. No upper limit is placed on the amount of chelating agent added, but from the perspective of treatment cost, the upper limit is preferably 5.00 g/L or less.

In the second impurity precipitation step, the chelating agent is added to the second treatment solution, obtained in the first impurity precipitation step, while the pH of the second treatment solution is 4.0 or more and 6.0 or less. By setting the pH of the second treatment solution at the time of adding the chelating agent to 4.0 or more, the chelating agent added in the second impurity precipitation step is prevented from decomposing, and complexes can be stably formed with heavy metal elements to efficiently remove the heavy metal elements. The lower limit of the pH of the second treatment solution is preferably 4.3, more preferably 4.5. The pH of the second treatment solution must be maintained at 6.0 or less, because a pH exceeding 6.0 will precipitate zinc, thus reducing the zinc concentration in the solution and reducing the zinc recovery rate as well. The upper limit of the pH of the second treatment solution is preferably 5.8, more preferably 5.5.

The pH of the second treatment solution obtained in the first impurity precipitation step is preferably maintained at 4.0 or more and 6.0 or less until the chelating agent is added. As described above, the pH of the second treatment solution needs to be maintained at 6.0 or less, but as long as the pH is 4.0 or more and 6.0 or less when the chelating agent is added, the pH of the second treatment solution may temporarily fall below 4.0.

The reaction time for the second impurity precipitation step is preferably 10 minutes or more. Here, a reaction time of 10 minutes or more allows sufficient precipitation of impurities in the second treatment solution. While no upper limit is placed on the reaction time, the reaction time is preferably 120 minutes or less to avoid prolonging the treatment time. The temperature of the second treatment solution in the second impurity precipitation step can be set freely within a temperature range such that the second treatment solution does not coagulate or evaporate. The temperature of the second treatment solution is preferably 30° C. or more in consideration of maintaining a constant temperature. The temperature of the second treatment solution is also preferably 90° C. or less, because an excessively high temperature increases evaporation of the second treatment solution.

### <First Solid-Liquid Separation Step>

Subsequently, in step S4, a third treatment solution, obtained in the second impurity precipitation step, is subjected to solid-liquid separation (first solid-liquid separation step).

This solid-liquid separation step is a step of subjecting the third treatment solution obtained in the second impurity precipitation step to solid-liquid separation into precipitated solids (hydroxides and chelate compounds of the impurities) and a fourth treatment solution. The method of solid-liquid separation is not particularly limited, and any method such as gravity settling separation, filtration, centrifugal separation, or a filter press can be selected.

### <Zinc Precipitation Step>

Subsequently, in step S5, a zinc-containing material is precipitated while the pH of a fourth treatment solution obtained in the first solid-liquid separation step is 8.0 or more and 12.0 or less (zinc precipitation step).

In this step, by setting the pH of the fourth treatment solution obtained in the first solid-liquid separation step to 8.0 or more and 12.0 or less, zinc contained in the fourth treatment solution is precipitated as a zinc-containing material. By setting the pH of the fourth coating solution to 8.0 or more, zinc can be precipitated efficiently. The pH of the fourth coating solution is therefore set to 8.0 or more. The lower limit of the pH of the fourth treatment solution is preferably 8.3, more preferably 8.5. Setting the pH of the fourth treatment solution to 12.0 or less can suppress re-dissolution of zinc. The pH of the fourth treatment solution is therefore 12.0 or less. The upper limit of the pH of the fourth treatment solution is preferably 11.8, more preferably 11.5.

If the pH of the fourth treatment solution obtained in the first solid-liquid separation step is less than 8.0, the pH of the fourth treatment solution needs to be adjusted to 8.0 or more and 12.0 or less. Examples of methods of adjusting the pH include adding a common alkaline solution such as sodium hydroxide or calcium hydroxide. On the other hand, if the pH of the fourth treatment solution obtained in the first solid-liquid separation step is within the range of 8.0 or more and 12.0 or less, the pH does not need to be adjusted.

The temperature of the fourth treatment solution in the zinc precipitation step can be set freely within a temperature range such that the fourth treatment solution does not coagulate or evaporate. The temperature of the fourth treatment solution is preferably 30° C. or more in consideration of maintenance of a constant temperature. On the other hand, if the temperature of the fourth treatment solution is too high, evaporation of the fourth treatment solution increases. The temperature of the fourth treatment solution is therefore preferably 90° C. or less. In consideration of the time it takes for impurities to precipitate and of treatment efficiency, the reaction time of the zinc precipitation step is preferably 10 minutes or more. The reaction time of the zinc precipitation step is preferably 120 minutes or less.

### <Second Solid-Liquid Separation Step>

Finally, in step S6, a fifth treatment solution, obtained in the zinc precipitation step, is subjected to solid-liquid separation and recovered (second solid-liquid separation step).

This second solid-liquid separation step is a step of subjecting the fifth treatment solution obtained in the zinc precipitation step to solid-liquid separation into a zinc-containing material and residual liquid. The method of solid-liquid separation is not particularly limited, and any method such as gravity settling separation, filtration, centrifugal separation, or a filter press can be selected. Since the zinc-containing material obtained in the second solid-liquid separation step contains water, drying treatment may be included after the second solid-liquid separation process as necessary.

A zinc-containing material can thus be prepared from steelmaking dust.

In the present disclosure, the zinc recovery rate is the ratio of the amount of zinc contained in the zinc-containing material to the amount of zinc contained in the steelmaking dust, expressed as a percentage. From the perspective of processing costs, the zinc recovery rate is preferably 10 mass % or more, more preferably 20 mass % or more.

The zinc-containing material obtained by the present disclosure can be used as part of an electrogalvanizing bath. The zinc-containing material can also be used as part of a plating bath for electroplating of metals containing zinc, such as Fe—Zn electroplating and Ni—Zn electroplating, and can be used to produce electroplated steel sheets having these electroplating layers on at least one side.

### <Classifying Step>

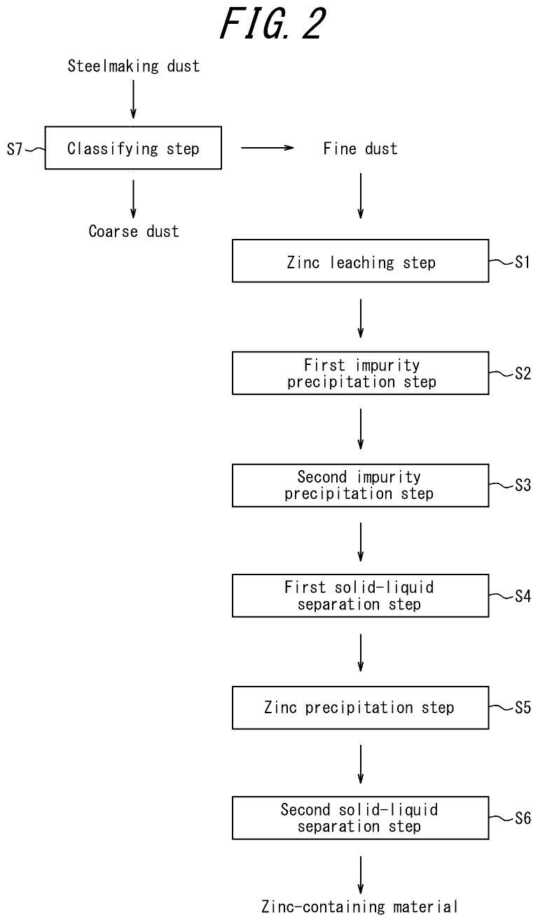

FIG. 2 is a flowchart of a preferred example method of preparing a zinc-containing material according to the present disclosure. As illustrated in FIG. 2, in the present disclosure, steelmaking dust is preferably separated into coarse dust and fine dust in step S7 in the stage preceding the zinc leaching step (classifying step). The fine dust obtained in this classifying step is then preferably used as the steelmaking dust for the zinc leaching step subsequent to the classifying step.

The zinc volatilized during the steelmaking process generally exists as fine particles of several micrometers in size and tends to have a lower specific gravity than iron. The fine dust thereby contains more zinc than the coarse dust. In addition, by virtue of having a smaller average particle size than coarse dust, fine dust is more reactive with the acidic aqueous solution in the subsequent zinc leaching step, thereby increasing the treatment efficiency of the zinc leaching reaction.

In the present disclosure, no particular limitation is placed on the average particle size of the fine dust in the case in which the fine dust obtained in this classifying step is used as the steelmaking dust for the zinc leaching step. However, from the perspective of achieving a high zinc content and high reactivity in the zinc leaching step, the average particle size of the fine dust is preferably 100 μm or less, more preferably 20 μm or less, and even more preferably 10 μm or less.

No particular limitations are placed on the method used in the classifying step. For example, the steelmaking dust can be separated into coarse dust and fine dust by using a sieve or by utilizing the difference in the settling velocity or movement velocity of particles in a fluid (fluid classification).

### (Method of Preparing an Electrogalvanizing Bath)

A method of preparing an electrogalvanizing bath according to the present disclosure includes adding the zinc-containing material prepared by the above-described method of preparing a zinc-containing material according to the present disclosure to an electrogalvanizing bath, the pH of the electrogalvanizing bath being 0.5 or more and 3.5 or less.

In addition to the zinc-containing material according to the present disclosure, zinc granules, zinc sulfate (heptahydrate), zinc chloride, and zinc carbonate, for example, can be used as zinc sources for the electrogalvanizing bath used in the present disclosure. An acidic bath with excellent productivity is preferred as the electrogalvanizing bath, and a sulfuric acid bath, a chloride bath, and a mixture of these baths can be used. However, a sulfuric acid bath is more preferably used, because a chloride bath requires treatment of chlorine gas generated when insoluble anodes are used.

The pH of the electrogalvanizing bath is preferably adjusted to be 0.5 or more. The pH is preferably adjusted to be 3.5 or less. The pH is more preferably adjusted to be 1.0 or more. The pH is more preferably adjusted to be 3.0 or less. By adjusting the pH of the electrogalvanizing bath to a range of 0.5 or more and 3.5 or less, it is possible to suppress active generation of hydrogen that would result in a decrease in current efficiency, while also suppressing the occurrence of plating burns in the coating or plating layer, thereby yielding a beautiful plating appearance. For pH adjustment, an acid corresponding to the type of electrogalvanizing bath is preferably used. For example, if the type of electrogalvanizing bath is a sulfuric acid bath, the pH is preferably adjusted with sulfuric acid.

No particular limitations are placed on the method of including the zinc-containing material, created by the method of preparing a zinc-containing material according to the present invention, as the zinc source of an electrogalvanizing bath. Examples of possible methods include a method of adding the zinc-containing material to an acidic bath prepared using a zinc source other than the zinc-containing material and then adjusting the pH.

The percentage of the zinc-containing material included as a zinc source in the electrogalvanizing bath is preferably 1.0 mass % or more in terms of total zinc source. This is because the present disclosure can yield a sufficient cost benefit when the percentage of the included zinc-containing material is 1.0 mass % or more. On the other hand, no upper concentration limit is placed on the percentage of the zinc-containing material, and the electrogalvanizing bath may be prepared using only the zinc-containing material as the zinc source.

The zinc concentration in the electrogalvanizing bath is preferably 0.5 mol/L or more. If the zinc concentration is 0.5 mol/L or more, no shortage of zinc ions will occur near the steel sheet to be plated during electrolysis, and the occurrence of plating burning can be suppressed. No upper limit is placed on the zinc concentration, but from the perspective of treatment cost, the upper limit is preferably 2 mol/L or less.

The temperature of the electrogalvanizing bath is preferably 30° C. or more in consideration of maintenance of a constant temperature. No particular upper limit is placed on the temperature of the electrogalvanizing bath, but a practical and preferred upper limit is about 90° C., because evaporation of the plating bath increases as the temperature rises.

In addition, a conductivity aid can be added to the plating bath as needed. The addition of a conductivity aid can improve the conductivity of the plating bath. Examples of conductivity aids include sodium sulfate, ammonium sulfate, and potassium sulfate. However, a larger amount of the additive may decrease the whiteness of the plating in a case in which electrolytic treatment is performed at a high current density. The added amount of the conductivity aid is therefore preferably 0.5 mol/L or less.

As a suitable range of concentration of impurity elements (Pb, Cd, Fe) included in the plating bath, the concentration of Pb and Cd is preferably 1.0 ppm or less. If the concentration of these impurity elements exceeds 1.0 ppm, the L value of the plated surface may decrease. For the same reason, the concentration of Fe is preferably 1000 ppm or less.

On the other hand, by adding an inorganic component containing Sn, In, Bi, or Sb or an organic component having a 2-benzothiazolylthio group to the plating bath as necessary, an electrogalvanized steel sheet with a more beautiful surface can be obtained. These inorganic and organic components are preferably controlled to be 0.01 ppm or more. These inorganic and organic components are preferably controlled to be 3 ppm or less. The form in which these components are added is not particularly limited. The aforementioned inorganic components may be added in a metallic state or in the form of sulfates, chlorides, carbonates, oxides, or the like. If a salt is used, it is preferable to use a salt corresponding to the type of electrogalvanizing bath. As the organic component having a 2-benzothiazolylthio group, 2-mercaptobenzothiazole (MBT) or a salt thereof can be used.

### (Method of Producing Electrogalvanized Steel Sheet)

A method of producing an electrogalvanized steel sheet according to the present disclosure includes electrogalvanizing a surface of a steel sheet using an electrogalvanizing bath prepared by the above-described method of preparing an electrogalvanizing bath according to the present disclosure to produce an electrogalvanized steel sheet. In the production of the electrogalvanized steel sheet, electroplating may be performed after the electroplating bath is prepared using the zinc-containing material and a zinc source other than the zinc-containing material, such as zinc granules or zinc sulfate. A zinc source containing the zinc-containing material prepared by the method of preparing a zinc-containing material according to the present disclosure may additionally be added to the electrogalvanizing bath in the electrogalvanized steel sheet production line.

The current density during electrolysis is preferably 10 A/dm² or more. The current density during electrolysis is preferably 130 A/dm² or less. The current density during electrolysis is more preferably 100 A/dm² or less. By setting the current density during electrolysis to 10 A/dm² or more, it is possible to prevent a decrease in the current efficiency and an increase in the time required to secure a predetermined coating weight. On the other hand, by setting the current density during electrolysis to 130 A/dm² or less, the occurrence of plating burn can be suppressed.

The type of counter electrode (anode) is not particularly limited, but considering the dissolution of impurities into the plating bath, an iridium oxide electrode is preferably used. The plating bath flow rate is preferably 1.0 m/s or more from the perspective of thinning the diffusion layer at the electrolytic interface.

The electrogalvanizing bath prepared by the method of preparing an electrogalvanizing bath according to the present disclosure can thus be used to produce an electrogalvanized steel sheet.

The electrogalvanized steel sheet produced as described above can also be made into a surface-treated steel sheet by forming a chemical conversion treatment coating on the surface thereof. The chemical conversion treatment coating can be formed by a chromium-free chemical conversion treatment in which, for example, a chromium-free chemical conversion treatment liquid is applied, and without washing with water, the steel sheet is heated and dried at a temperature of 80° C. to 300° C. The chemical conversion treatment coating may have a single-layer structure or a multilayer structure, and in case of a multilayer structure, chemical conversion treatment can be performed multiple times sequentially.

Furthermore, according to the application of the electrogalvanized steel sheet, a single or multilayer coating film containing organic resin can be formed on the surface of the coating or plating layer or the chemical conversion treatment coating of the electrogalvanized steel sheet produced as described above to yield a surface-treated steel sheet. Examples of the coating film include a polyester resin coating film, epoxy resin coating film, acrylic resin coating film, urethane resin coating film, and fluorine resin coating film.

A coating film in which some of the aforementioned resin is modified with another resin, such as an epoxy-modified polyester resin coating film, can also be applied. Furthermore, a curing agent, a curing catalyst, a pigment, an additive, or the like may be added to the aforementioned resins as needed. The coating method for forming the coating film is not particularly

limited, but examples of the coating method include roll coater coating, curtain flow coating, and spray coating. The coating film can be formed by, for example, applying paint containing organic resin to the surface of the coating or plating layer or the chemical conversion treatment coating, and then heating and drying by means such as hot air drying, infrared heating, or induction heating.

The above method of producing a surface-treated steel sheet is only a non-limiting example.

### Examples

Hereinafter, examples of the disclosure will be described, but the disclosure is not limited to the examples.

First, electric furnace dust (zinc content: 40 mass %, average particle size: 10 μm) as steelmaking dust was added to a sulfuric acid solution adjusted to pH 2.0 and stirred for 1 hour to leach zinc into the sulfuric acid solution (zinc leaching step). The resulting solution was then subjected to impurity precipitation treatment (first impurity precipitation step and second impurity precipitation step) by adjusting the bath under various conditions. Table 1 illustrates the type of chelating agent, and Table 2 illustrates the amount of electric furnace dust added, the type of alkaline solution used for pH adjustment and the pH of the solution after pH adjustment in the first impurity precipitation step, and the type and amount of chelating agent added in the second impurity precipitation step. Also illustrated are the structural formulas for A1 to A4 in Table 1. In the impurity precipitation treatment, both the first impurity precipitation step and the second impurity precipitation step were performed while stirring for 1 hour after bath adjustment under a set of conditions including a solution temperature of 50° C. Subsequently, solid-liquid separation was performed using a suction filtration device (first solid-liquid separation step), the resulting solution was adjusted to pH 9.0 (zinc precipitation step), after which solid-liquid separation was performed using a suction filtration device (second solid-liquid separation step), and the resulting solid was dried at 105° C. to obtain a zinc-containing material. The pH of the zinc precipitation step was adjusted using a sodium hydroxide solution. The zinc recovery rate from electric furnace dust and the ratios of Fe, Cd, and Pb in the zinc-containing material are listed for each No. in Table 2.

TABLE 1

| No. | Compound name |
|---|---|
| A1 | Sodium dimethyldithiocarbamate |
| A2 | Sodium diethyldithiocarbamate |
| A3 | Dipotassium piperazine-1,4-dicarbodithioate |
| A4 | Ammonium 1-pyrrolidinedithiocarbamate |

TABLE 2

| | | | | Second impurity | | | | | | | |
|---|---|---|---|---|---|---|---|---|---|---|---|
| | Electric | First impurity | | precipitation step | | Zinc | Impurity ratio in | | | Electrogalvanizing bath | |
| | furnace dust | precipitation step | | Chelating agent | | recovery | zinc-containing material | | | Zn | Zinc-containing |
| | added amount | Alkali | | | Added amount | rate | Fe | Cd | Pb | concentration | material ratio |
| No. | g/L | Type | pH | Type | g/L | mass % | mass % | mass % | mass % | mol/L | mass % |
| 1 | 82 | — | — | — | — | 100 | 1.50 | 0.0600 | 0.0450 | 1.5 | 33.3 |
| 2 | 82 | NaOH | 5.0 | — | — | 100 | 0.10 | 0.0600 | 0.0100 | 1.5 | 33.3 |
| 3 | 82 | — | — | A1 | 0.50 | 100 | 1.50 | 0.0600 | 0.0450 | 1.5 | 33.3 |
| 4 | 82 | NaOH | 3.9 | A1 | 0.50 | 100 | 0.30 | 0.0600 | 0.0450 | 1.5 | 33.3 |
| 5 | 82 | NaOH | 6.1 | A1 | 0.50 | 2 | 1.00 | 0.0500 | 0.0500 | 1.5 | 0.7 |
| 6 | 82 | NaOH | 5.0 | A1 | 0.09 | 100 | 0.10 | 0.0100 | 0.0050 | 1.5 | 33.3 |
| 7 | 82 | NaOH | 5.0 | A1 | 0.50 | 100 | 0.10 | 0.0010 | 0.0010 | 1.5 | 33.3 |
| 8 | 82 | NaOH | 5.0 | A2 | 0.50 | 100 | 0.10 | 0.0010 | 0.0010 | 1.5 | 33.3 |
| 9 | 82 | NaOH | 5.0 | A3 | 0.50 | 100 | 0.10 | <0.0005 | <0.0005 | 1.5 | 33.3 |
| 10 | 82 | NaOH | 5.0 | A4 | 0.50 | 100 | 0.10 | <0.0005 | <0.0005 | 1.5 | 33.3 |
| 11 | 82 | NaOH | 4.2 | A4 | 0.50 | 100 | 0.20 | 0.0010 | 0.0010 | 1.5 | 33.3 |
| 12 | 82 | NaOH | 5.8 | A4 | 0.50 | 40 | 0.05 | <0.0005 | <0.0005 | 1.5 | 13.3 |
| 13 | 82 | NaOH | 5.0 | A4 | 0.12 | 100 | 0.10 | 0.0010 | 0.0010 | 1.5 | 33.3 |
| 14 | 82 | NaOH | 5.0 | A4 | 0.20 | 100 | 0.10 | 0.0006 | 0.0006 | 1.5 | 33.3 |
| 15 | 82 | NaOH | 5.0 | A4 | 0.30 | 100 | 0.10 | 0.0005 | 0.0005 | 1.5 | 33.3 |
| 16 | 82 | NaOH | 5.0 | A4 | 1.00 | 100 | 0.10 | <0.0005 | <0.0005 | 1.5 | 33.3 |
| 17 | 82 | NaOH | 5.0 | A4 | 3.00 | 100 | 0.10 | <0.0005 | <0.0005 | 1.5 | 33.3 |
| 18 | 82 | Ca(OH)₂ | 4.2 | A4 | 0.20 | 100 | 0.20 | 0.0010 | 0.0010 | 1.5 | 33.3 |
| 19 | 82 | Ca(OH)₂ | 5.8 | A4 | 0.30 | 40 | 0.05 | <0.0005 | <0.0005 | 1.5 | 13.3 |
| 20 | 82 | Ca(OH)₂ | 5.0 | A4 | 0.20 | 100 | 0.10 | 0.0006 | 0.0006 | 1.5 | 33.3 |
| 21 | 82 | Ca(OH)₂ | 5.0 | A4 | 0.30 | 100 | 0.10 | 0.0005 | 0.0005 | 1.5 | 33.3 |
| 22 | 82 | Ca(OH)₂ | 5.0 | A4 | 0.50 | 100 | 0.10 | <0.0005 | <0.0005 | 1.5 | 33.3 |
| 23 | 3 | — | — | — | — | 100 | 1.50 | 0.0600 | 0.0450 | 1.5 | 1.1 |
| 24 | 3 | NaOH | 5.0 | A4 | 0.50 | 100 | 0.10 | <0.0005 | <0.0005 | 1.5 | 1.1 |
| 25 | 82 | NaOH | 5.0 | A4 | 0.50 | 100 | 0.10 | <0.0005 | <0.0005 | 0.5 | 100 |
| 26 | 82 | NaOH | 5.0 | A4 | 0.50 | 100 | 0.10 | <0.0005 | <0.0005 | 1.5 | 33.3 |

| | | | | | Evaluation results | | | | |
|---|---|---|---|---|---|---|---|---|---|
| | Electrogalvanizing bath | | | | | | Chromium-free | | |
| | | | | Added amount | | | chemical conversion | | |
| | Fe | Cd | Pb | of MBT | Plated steel sheet | | treatment steel sheet | | |
| No. | ppm | ppm | ppm | ppm | L value | Evaluation | L value | Evaluation | Notes |
| 1 | 1500 | 60.0 | 45.0 | 0.0 | 72 | X | 52 | X | Comparative |
| | | | | | | | | | Example |
| 2 | 100 | 60.0 | 10.0 | 0.0 | 73 | X | 53 | X | Comparative |
| | | | | | | | | | Example |
| 3 | 1500 | 60.0 | 45.0 | 0.0 | 72 | X | 52 | X | Comparative |
| | | | | | | | | | Example |
| 4 | 300 | 60.0 | 45.0 | 0.0 | 73 | X | 53 | X | Comparative |
| | | | | | | | | | Example |
| 5 | 20 | 1.0 | 1.0 | 0.0 | 79 | ◯ | 59 | X | Comparative |
| | | | | | | | | | Example |
| 6 | 100 | 10.0 | 5.0 | 0.0 | 75 | X | 55 | X | Comparative |
| | | | | | | | | | Example |
| 7 | 100 | 1.0 | 1.0 | 0.0 | 78 | ◯ | 58 | ◯ | Example |
| 8 | 100 | 1.0 | 1.0 | 0.0 | 78 | ◯ | 58 | ◯ | Example |
| 9 | 100 | <0.5 | <0.5 | 0.0 | 82 | ⊚ | 62 | ⊚ | Example |
| 10 | 100 | <0.5 | <0.5 | 0.0 | 82 | ⊚ | 62 | ⊚ | Example |
| 11 | 200 | 1.0 | 1.0 | 0.0 | 79 | ◯ | 59 | ◯ | Example |
| 12 | 20 | <0.5 | <0.5 | 0.0 | 82 | ⊚ | 62 | ⊚ | Example |
| 13 | 100 | 1.0 | 1.0 | 0.0 | 78 | ◯ | 58 | ◯ | Example |
| 14 | 100 | 0.6 | 0.6 | 0.0 | 80 | ⊚ | 60 | ⊚ | Example |
| 15 | 100 | 0.5 | 0.5 | 0.0 | 80 | ⊚ | 60 | ⊚ | Example |
| 16 | 100 | <0.5 | <0.5 | 0.0 | 82 | ⊚ | 62 | ⊚ | Example |
| 17 | 100 | <0.5 | <0.5 | 0.0 | 82 | ⊚ | 62 | ⊚ | Example |
| 18 | 200 | 1.0 | 1.0 | 0.0 | 78 | ◯ | 58 | ◯ | Example |
| 19 | 20 | <0.5 | <0.5 | 0.0 | 81 | ⊚ | 61 | ⊚ | Example |
| 20 | 100 | 0.6 | 0.6 | 0.0 | 80 | ⊚ | 60 | ⊚ | Example |
| 21 | 100 | 0.5 | 0.5 | 0.0 | 80 | ⊚ | 60 | ⊚ | Example |
| 22 | 100 | <0.5 | <0.5 | 0.0 | 82 | ⊚ | 62 | ⊚ | Example |
| 23 | 48 | 1.9 | 1.4 | 0.0 | 75 | X | 55 | X | Comparative |
| | | | | | | | | | Example |
| 24 | 3 | <0.5 | <0.5 | 0.0 | 82 | ⊚ | 62 | ⊚ | Example |
| 25 | 100 | <0.5 | <0.5 | 0.0 | 82 | ⊚ | 62 | ⊚ | Example |
| 26 | 100 | <0.5 | <0.5 | 0.3 | 85 | ⊚ | 65 | ⊚ | Example |

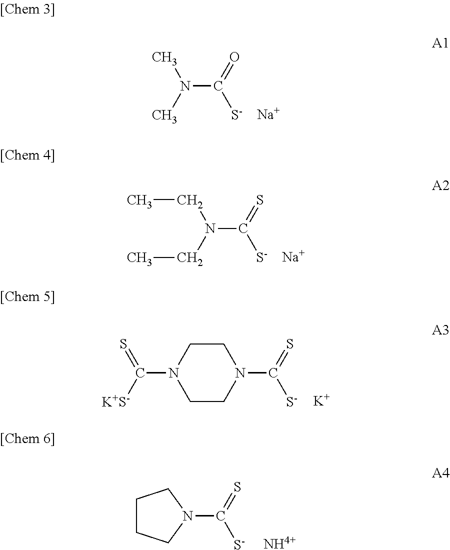

After preparing electrogalvanizing baths in which the zinc-containing material obtained as described above and zinc sulfate heptahydrate were used to adjust the bath zinc concentration to the concentrations illustrated in Table 2, electrogalvanization was performed under the set of conditions illustrated below to produce electrogalvanized steel sheets. In this case, a cold-rolled steel sheet with a thickness of 0.7 mm produced by a conventional method was used as the coating blank sheet. Test pieces (150 mm×70 mm) for use in batch electrogalvanization were cut from this steel sheet, degreased, pickled, and then subjected to electrogalvanization. The zinc coating weight per side was 20 g/m² in all cases.

### Electrolysis Conditions

Current density: 50 A/dm²
Bath temperature: 50° C.
Electrodes: iridium oxide
Flow rate: 2.0 m/s

Furthermore, the plated surface of the resulting electrogalvanized steel sheets was coated with an epoxy resin (produced by Japan Epoxy Resins Co., Ltd., product name: jER1009) to prepare chromium-free chemical conversion treatment steel sheets.

The brightness (L value) of the resulting electrogalvanized steel sheets and chromium-free chemical conversion treatment steel sheets was measured in accordance with JIS Z8722: 2009 by SCE (Specular Component Excluded) using a spectrophotometer (SD5000 produced by Nippon Denshoku Industries Co., Ltd.). The electrogalvanized steel sheets were evaluated as ⊚ if the L value was 80 or more, ◯ if the L value was 76 or more and less than 80, and X if the L value was less than 76. The chromium-free chemical conversion treatment steel sheets were evaluated as ⊚ if the L value was 60 or more, ◯ if the L value was 56 or more and less than 60, and X if the L value was less than 56. Note that ⊚, ◯, and X are in order from better to worse.

No. 1 in Table 2 is a comparative example of an electrogalvanized steel sheet and a chromium-free chemical conversion treatment steel sheet subjected to electrogalvanization without performance of either the first impurity precipitation step or the second impurity precipitation step. The amount of impurities in the zinc-containing material was large, resulting in a high concentration of impurities included in the electrogalvanizing bath and low L values. No. 2 is a comparative example on which only the first impurity precipitation step was performed. Although the Fe ratio in the zinc-containing material decreased, Cd and Pb still remained, resulting in high Cd and Pb concentrations in the electrogalvanizing bath and low L values. No. 3 is a comparative example in which only the second impurity precipitation step was performed. The impurity ratio in the zinc-containing material was as high as No. 1 due to the low pH and decomposition of the chelating agent, resulting in a high concentration of impurities included in the electrogalvanizing bath and low L values. No. 4 is a comparative example in which the pH was outside of the lower limit in the first impurity precipitation step. Although the Fe ratio in the zinc-containing material decreased, Cd and Pb remained in the zinc-containing material due to the low pH and decomposition of the chelating agent, and the L values were also low. No. 5 is a comparative example in which the pH was outside of the upper limit in the first impurity precipitation step and was unsuitable as a zinc source for electrogalvanization due to the greatly reduced zinc recovery rate. No. 6 is a comparative example in which the added amount of chelate compound was outside of the lower limit. The Cd and Pb ratios in the zinc-containing material were not sufficiently reduced, and the L values were also low.

On the other hand, the examples in Nos. 7 to 22 had reduced Fe, Cd, and Pb ratios without significantly decreasing the Zn concentration of the zinc-containing material, and the concentration of impurities included in the electrogalvanizing bath was also sufficiently reduced, resulting in high L values.

In No. 23 and No. 24, the percentage of the prepared zinc-containing material as a zinc source in the electrogalvanizing bath was 1.1 mass %, which is near the lower end of the suitable range in the present disclosure. No. 23 is a comparative example prepared without performance of either the first impurity precipitation step or the second impurity precipitation step. The concentration of impurities in the electrogalvanizing bath was outside the acceptable range due to the effect of impurities included in the zinc-containing material, resulting in low L values. On the other hand, in the example in No. 24, in which both the first impurity precipitation step and second impurity precipitation step were performed, the ratios of Fe, Cd, and Pb in the electrogalvanizing bath were reduced, and the L values were also high. No. 25 is an example in which the electrogalvanizing bath was adjusted using only zinc-containing material. The Fe, Cd, and Pb ratios in the zinc-containing material were sufficiently low, and the concentration of impurities in the electrogalvanizing bath was also low, resulting in high L values. Furthermore, No. 26 is an example in which MBT was added to the example in No. 10, and the L values increased as compared to No. 10, which did not include MBT.

### INDUSTRIAL APPLICABILITY

According to the present disclosure, a zinc-containing material that is made from steelmaking dust and that can be used to produce electrogalvanized steel sheets with a beautiful, bright appearance can be provided.

1. A method of preparing a zinc-containing material, the method comprising:
a zinc leaching step of bringing steelmaking dust into contact with an acidic aqueous solution to leach zinc contained in the steelmaking dust into the acidic aqueous solution;
a first impurity precipitation step of precipitating impurities while a pH of a first treatment solution obtained in the zinc leaching step is 4.0 or more and 6.0 or less;
a second impurity precipitation step of adding 0.10 g/L or more of a chelating agent to a second treatment solution, obtained in the first impurity precipitation step, while a pH of the second treatment solution is 4.0 or more and 6.0 or less to precipitate impurities;
a first solid-liquid separation step of subjecting a third treatment solution, obtained in the second impurity precipitation step, to solid-liquid separation;
a zinc precipitation step of precipitating a zinc-containing material while a pH of a fourth treatment solution obtained in the first solid-liquid separation step is 8.0 or more and 12.0 or less; and
a second solid-liquid separation step of separating a fifth treatment solution obtained in the zinc precipitation step into a zinc-containing material and residual liquid.

2. The method of preparing a zinc-containing material according to claim 1, further comprising a classifying step of separating steelmaking dust into coarse dust and fine dust in a stage preceding the zinc leaching step, wherein the steelmaking dust used in the zinc leaching step is the fine dust obtained in the classifying step.

3. The method of preparing a zinc-containing material according to claim 1, wherein at least one type of the chelating agent added to the second treatment solution in the second impurity precipitation step is a chelating agent that forms a chelate compound with at least one of Cd and Pb.

4. The method of preparing a zinc-containing material according to claim 1, wherein at least one type of the chelating agent added to the second treatment solution in the second impurity precipitation step is a compound having a structure illustrated in general formula (I) in a portion thereof, 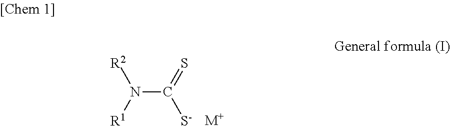
where R¹ and R² represent an optionally substituted alkyl group, and M⁺ represents a monovalent cation.

5. A method of preparing an electrogalvanizing bath, the method comprising adding a zinc-containing material prepared by the method of preparing a zinc-containing material according to claim 1 to an electrogalvanizing bath, wherein a pH of the electrogalvanizing bath is 0.5 or more and 3.5 or less.

6. A method of producing an electrogalvanized steel sheet, the method comprising electrogalvanizing a surface of a steel sheet using an electrogalvanizing bath prepared by the method of preparing an electrogalvanizing bath according to claim 5 to produce an electrogalvanized steel sheet.

7. The method of preparing a zinc-containing material according to claim 2, wherein at least one type of the chelating agent added to the second treatment solution in the second impurity precipitation step is a chelating agent that forms a chelate compound with at least one of Cd and Pb.

8. The method of preparing a zinc-containing material according to claim 2, wherein at least one type of the chelating agent added to the second treatment solution in the second impurity precipitation step is a compound having a structure illustrated in general formula (I) in a portion thereof, 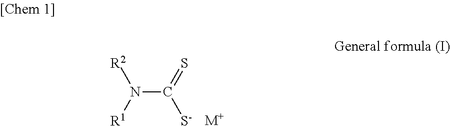
where R¹ and R² represent an optionally substituted alkyl group, and M⁺ represents a monovalent cation.

9. The method of preparing a zinc-containing material according to claim 3, wherein at least one type of the chelating agent added to the second treatment solution in the second impurity precipitation step is a compound having a structure illustrated in general formula (I) in a portion thereof, 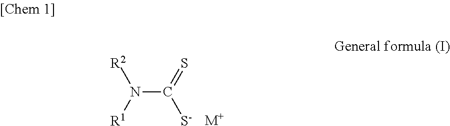
where R¹ and R² represent an optionally substituted alkyl group, and M⁺ represents a monovalent cation.

10. The method of preparing a zinc-containing material according to claim 7, wherein at least one type of the chelating agent added to the second treatment solution in the second impurity precipitation step is a compound having a structure illustrated in general formula (I) in a portion thereof, 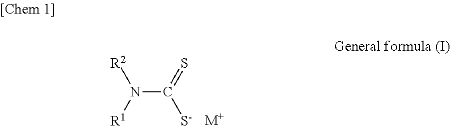
where R¹ and R² represent an optionally substituted alkyl group, and M⁺ represents a monovalent cation.

11. A method of preparing an electrogalvanizing bath, the method comprising adding a zinc-containing material prepared by the method of preparing a zinc-containing material according to claim 2 to an electrogalvanizing bath, wherein a pH of the electrogalvanizing bath is 0.5 or more and 3.5 or less.

12. A method of preparing an electrogalvanizing bath, the method comprising adding a zinc-containing material prepared by the method of preparing a zinc-containing material according to claim 3 to an electrogalvanizing bath, wherein a pH of the electrogalvanizing bath is 0.5 or more and 3.5 or less.

13. A method of preparing an electrogalvanizing bath, the method comprising adding a zinc-containing material prepared by the method of preparing a zinc-containing material according to claim 4 to an electrogalvanizing bath, wherein a pH of the electrogalvanizing bath is 0.5 or more and 3.5 or less.

14. A method of preparing an electrogalvanizing bath, the method comprising adding a zinc-containing material prepared by the method of preparing a zinc-containing material according to claim 7 to an electrogalvanizing bath, wherein a pH of the electrogalvanizing bath is 0.5 or more and 3.5 or less.

15. A method of preparing an electrogalvanizing bath, the method comprising adding a zinc-containing material prepared by the method of preparing a zinc-containing material according to claim 8 to an electrogalvanizing bath, wherein a pH of the electrogalvanizing bath is 0.5 or more and 3.5 or less.

16. A method of preparing an electrogalvanizing bath, the method comprising adding a zinc-containing material prepared by the method of preparing a zinc-containing material according to claim 9 to an electrogalvanizing bath, wherein a pH of the electrogalvanizing bath is 0.5 or more and 3.5 or less.

17. A method of preparing an electrogalvanizing bath, the method comprising adding a zinc-containing material prepared by the method of preparing a zinc-containing material according to claim 10 to an electrogalvanizing bath, wherein a pH of the electrogalvanizing bath is 0.5 or more and 3.5 or less.
